(19) United States
(12) Patent Application Publication
(10) Pub. No.: US 2016/0217209 A1
(43) Pub. Date: Jul. 28, 2016

(54) Measuring Corpus Authority for the Answer to a Question

(71) Applicant: International Business Machines Corporation, Armonk, NY (US)

(72) Inventors: Bridget B. Beamon, Cedar Park, TX (US); Nikolaus K. Brauer, Austin, TX (US); Nirav P. Desai, Austin, TX (US); Kevin B. Haverlock, Cary, NC (US); Michael D. Whitley, Durham, NC (US)

(21) Appl. No.: 14/602,426

(22) Filed: Jan. 22, 2015

(51) Int. Cl. G06F 17/30

(52) U.S. Cl. CPC G06F 17/30707

(57) ABSTRACT

A mechanism is provided in a data processing system for determining source authority for an answer to a question. The mechanism receives an input question from a user interface and determines a set of answers to the input question from a corpus of information. The corpus of information comprises a plurality of sources of information. For a given answer in the set of answers, the mechanism identifies a given source of a supporting passage. The mechanism determines an authority score of the given source for the input question. The mechanism presents the set of answers to the user interface based on the authority score for the given source.

### BACKGROUND

The present application relates generally to an improved data processing apparatus and method and more specifically to mechanisms for measuring corpus authority for the answer to a question.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

Examples, of QA systems are Siri® from Apple®, Cortana® from Microsoft®, and the IBM Watson™ system available from International Business Machines (IBM®) Corporation of Armonk, New York. The IBM Watson™ system is an application of advanced natural language processing, information retrieval, knowledge representation and reasoning, and machine learning technologies to the field of open domain question answering. The IBM Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

### SUMMARY

In one illustrative embodiment, a method, in a data processing system, is provided for determining source authority for an answer to a question. The method comprises receiving an input question from a user interface and determining a set of answers to the input question from a corpus of information. The corpus of information comprises a plurality of sources of information. The method further comprises, for a given answer in the set of answers, identifying a given source of a supporting passage. The mechanism further comprises determining an authority score of the given source for the input question and presenting the set of answers to the user interface based on the authority score for the given source.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QA) system in a computer network;

FIG. 2 is a block diagram of an example data processing system in which aspects of the illustrative embodiments are implemented;

FIG. 3 illustrates a QA system pipeline for processing an input question in accordance with one illustrative embodiment;

FIG. 4 is a block diagram of a mechanism for training a question answering system for determining authority of a document source for the answer to a question in accordance with an illustrative embodiment;

FIG. 5 is a block diagram illustrating a question answering system for determining authority score values for source documents in a corpus in accordance with an illustrative embodiment;

FIG. 6 is a flowchart illustrating operation of a mechanism for training a model for measuring authority of a document source for the answer to a question in accordance with an illustrative embodiment; and

FIG. 7 is a flowchart illustrating operation of a mechanism for measuring authority of a document source of an answer to a question in accordance with an illustrative embodiment.

### DETAILED DESCRIPTION

The illustrative embodiments provide mechanisms for measuring corpus authority for an answer to a question. In particular applications of a question answering (QA) system, the domain of a corpus may contain hundreds of sources of documents that make up the corpus. Consider the question, “What drug has been shown to relieve the symptoms of ADD with relatively few side effects?” In this example, one source may be the New England Journal of Medicine and another source may be Parents Magazine. A QA system can draw on hundreds of corpus sources, but no source can answer all questions with authority. In the above example, one would expect Parents Magazine to provide some evidentiary support for the above question but not be an authoritative source for effectiveness and known side effects of pharmaceuticals.

Thus, the illustrative embodiments provide a mechanism for generating an authority score for a source of a given question. The authority score is different from the confidence of the answer itself, although the authority score may contribute to the confidence score in some embodiments. Rather, the authority score represents the confidence that the source of an answer is an authoritative source for the subject matter of the question.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

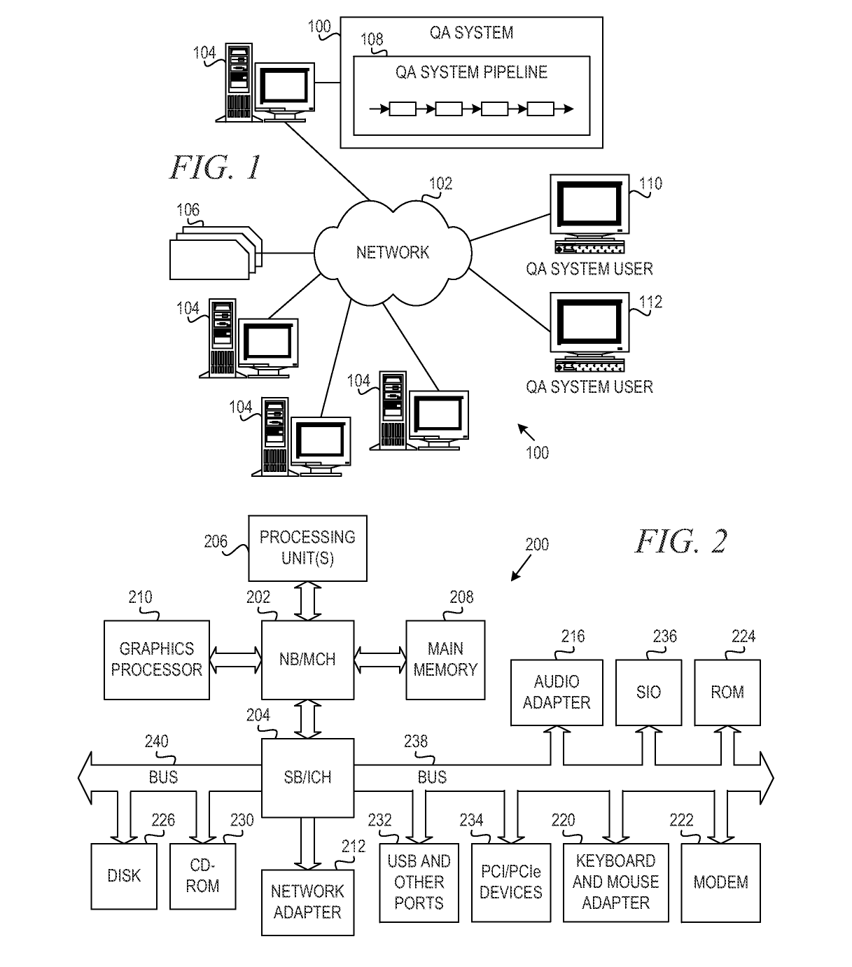

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply arty limitation with regard to the environments in which aspects or embodiments of the present invention may be implemented. Many modifications to the depicted environments may be made without departing from the spirit and scope of the present invention.

FIGS. 1-3 are directed to describing an example Question Answering (QA) system (also referred to as a Question/Answer system or Question and Answer system), methodology, and computer program product with which the mechanisms of the illustrative embodiments are implemented. As will be discussed in greater detail hereafter, the illustrative embodiments are integrated in, augment, and extend the functionality of these QA mechanisms with regard to measuring corpus authority for an answer to a question.

Thus, it is important to first have an understanding of how question and answer creation in a QA system is implemented before describing how the mechanisms of the illustrative embodiments are integrated in and augment such QA systems. It should be appreciated that the QA mechanisms described in FIGS. 1-3 are only examples and are not intended to state or imply any limitation with regard to the type of QA mechanisms with which the illustrative embodiments are implemented. Many modifications to the example QA system shown in FIGS. 1-3 may be implemented in various embodiments of the present invention without departing from the spirit and scope of the present invention.

As an overview, a Question Answering system (QA system) is an artificial intelligence application executing on data processing hardware that answers questions pertaining to a given subject-matter domain presented in natural language. The QA system receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system. The document may include any file, text, article, or source of data for use in the QA system. For example, a QA system accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to the QA system which then answers the input questions using the content in the corpus of data by evaluating documents, sections of documents, portions of data in the corpus, or the like. When a process evaluates a given section of a document for semantic content, the process can use a variety of conventions to query such document from the QA system, e.g., sending the query to the QA system as a well-formed question which are then interpreted by the QA system and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA system receives an input question, parses the question to extract the major features of the question, uses the extracted features to formulate queries, and then applies those queries to the corpus of data. Based on the application of the queries to the corpus of data, the QA system generates a set of hypotheses, or candidate answers to the input question, by looking across the corpus of data for portions of the corpus of data that have some potential for containing a valuable response to the input question. The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model is used to summarize a level of confidence that the QA system has regarding the evidence that the potential response, i.e. candidate answer, is inferred by the question. This process is repeated for each of the candidate answers until the QA system identifies candidate answers that surface as being significantly stronger than others and thus, generates a final answer, or ranked set of answers, for the input question.

As mentioned above, QA systems and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA system. Content creators, automated tools, or the like, annotate or otherwise generate metadata for providing information useable by the QA system to identify these questions and answer attributes of the content.

Operating on such content, the QA system generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a question/answer creation (QA) system 100 in a computer network 102. One example of a question/answer generation which may be used in conjunction with the principles described herein is described in U.S. Patent Application Publication No. 2011/0125734, which is herein incorporated by reference in its entirety. The QA system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The QA system 100 and network 102 enables question/answer (QA) generation functionality for one or more QA system users via their respective computing devices 110-112. Other embodiments of the QA system 100 may be used with components, systems, sub-systems, and/or devices other than those that are depicted herein.

The QA system 100 is configured to implement a QA system pipeline 108 that receive inputs from various sources. For example, the QA system 100 receives input from the network 102, a corpus of electronic documents 106, QA system users, and/or other data and other possible sources of input. In one embodiment, some or all of the inputs to the QA system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the QA system 100 may operate in environments of any size, including local and global, e.g., the Internet.

In one embodiment, the content creator creates content in a document of the corpus of data 106 for use as part of a corpus of data with the QA system 100. The document includes any file, text, article, or source of data for use in the QA system 100. QA system users access the QA system 100 via a network connection or an Internet connection to the network 102, and input questions to the QA system 100 that are answered by the content in the corpus of data 106. In one embodiment, the questions are formed using natural language. The QA system 100 parses and interprets the question, and provides a response to the QA system user, e.g., QA system user 110, containing one or more answers to the question. In some embodiments, the QA system 100 provides a response to users in a ranked list of candidate answers while in other illustrative embodiments, the QA system 100 provides a single final answer or a combination of a final answer and ranked listing of other candidate answers.

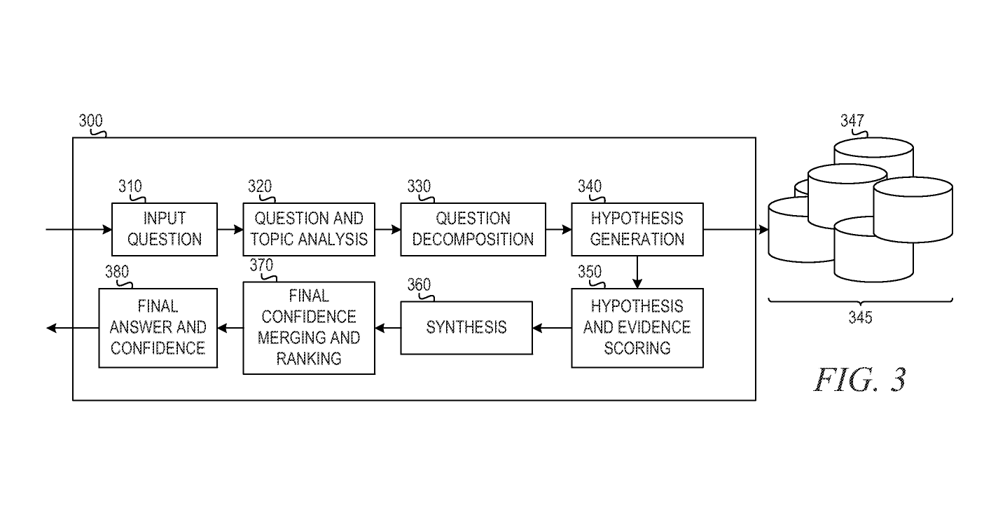

The QA system 100 implements a QA system pipeline 108 which comprises a plurality of stages for processing an input question and the corpus of data 106. The QA system pipeline 108 generates answers for the input question based on the processing of the input question and the corpus of data 106. The QA system pipeline 108 will be described in greater detail hereafter with regard to FIG. 3.

In some illustrative embodiments, the QA system 100 may be the IBM Watson™ QA system available from international Business Machines Corporation of Armonk, N.Y., which is augmented with the mechanisms of the illustrative embodiments described hereafter. As outlined previously, the IBM Watson™ QA system receives an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The IBM Watson™ QA system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the IBM Watson™ QA system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

In accordance with an illustrative embodiment, QA system users at clients 110, 112 submit questions to QA system 100, which generates candidate answers from corpus documents 106 and determines an authority score for each source of an answer. One or more reasoning algorithms or stages of QA system pipeline 108 determine an authority score based on the topic of the question that was asked. The mechanisms of the illustrative embodiments determine the authority score based on features and classifications of the question, as well as features of the document, to measure the relevancy of the document source.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a QA system 100 and QA system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing, unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a QA system pipeline for processing an input question in accordance with one illustrative embodiment. The QA system pipeline of FIG. 3 may be implemented, for example, as QA system pipeline 108 of QA system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user inputs, via a user interface, an input question for which the user wishes to obtain an answer, e.g., “Who are Washington's closest advisors′?” In response to receiving the input question, the next stage of the QA system pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with atopic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to took for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

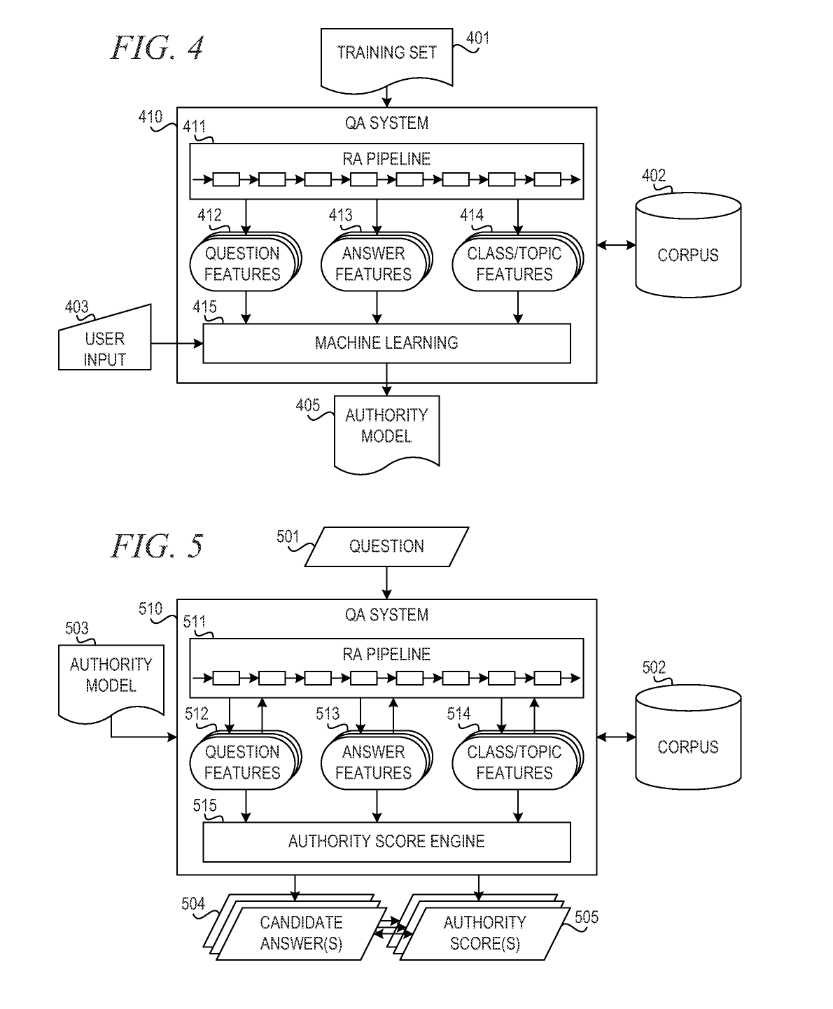

In accordance with the illustrative embodiments, hypothesis and evidence scoring phase 350 includes reasoning algorithms for determining an authority score for sources of documents providing evidentiary support for answers. Operation of a mechanism for determining authority of a document source is described in further detail below with reference to FIGS. 4-7.

Final confidence merging and ranking stage 370 includes reasoning algorithms for integrating authority of document sources. In one embodiment, a filtering mechanism uses authority scores to determine the likelihood that the source contains the correct answer. The mechanism uses a predetermined threshold to allow or not allow an answer through to additional pipeline processing. In one example embodiment, the mechanism filters answers based on document source authority before running resource intensive deep scorers. For example, the filtering mechanism may exist in hypotheses generation stage 340.

In another embodiment, final confidence merging and ranking stage 370 uses the authority score of document sources in determining answer confidence scores and answering ranking. Final confidence merging and ranking stage 370 may use authority score information to allow the logistic regression model to determine the usefulness in question answering.

FIG. 4 is a block diagram of a mechanism for training a question answering system for determining authority of a document source for the answer to a question in accordance with an illustrative embodiment. Question answering (QA) system 410 receives training set 401 of labeled questions and answers. Training set 401 is representative of the type of questions that may be asked of the trained reasoning algorithm (RA) pipeline 411. QA system 410 generates answer results including the source of supporting passages from corpus 402.

More particularly, RA pipeline 411 generates question features 412 and answer features 413. Question features 412 include Lexical Answer Type (LAT) and a set of question classifications. In one example embodiment, question features 412 also include a confidence that RA pipeline 411 determined the correct LAT. Question classifications include date, number, factoid, etc. These question classifications are detected, in part, via the LAT. In accordance with the illustrative embodiment, the question classifications are expanded to encompass more specific topics, such as economic or region. Given the LAT and any other question analysis performed, RA pipeline 411 maps each question to one or more question classifications in class/topic features 414.

In one embodiment, class/topic features 414 are binary features representing question classifications and topics. That is, a question classification is represented by a binary value of 0 for false and 1 for true. For example, the question, “When will the next president be inaugurated?” would have a QClass-DATE feature value of 1 and a QClass-NUMBER feature value of 0. To expand question classifications to topics, a question asking about gross domestic product (GDP) would have a QClass-ECONOMIC feature value of 1.

In one embodiment, machine learning component 415 uses a logistic regression to train authority model 405. Logistic regression produces a score between 0 and 1 according to the following formula:

$$f ( x ) = \frac{1}{1 + {e}^{- {β}_{0} - {\sum }_{m = 1}^{M} {β}_{m} - {x}_{m}}} ,$$

where m ranges over the M features for instance x and β₀ is the “intercept” or “bias” term. An instance x is a vector of numerical feature values, corresponding to one single occurrence of whatever the logistic regression is intended to classify. Output f(x) is used like a probability, and learned parameters βₘ are interpreted as “weights” gauging the contribution of each feature. For example, a logistic regression to classify carrots as edible or inedible would have one instance per carrot, and each instance would list numerical features such as the thickness and age of that carrot. The training data consist of many such instances along with labels indicating the correct f(x) value for each (e.g., 1 for edible and 0 for inedible carrots). The learning system computes the model (the β vector) that provides the best fit between f(x) and the labels in the training data. That model, the authority model in the illustrative embodiments, is then used on test data to classify instances.

Machine learning component 415 uses the following features 412-414 for training authority model 405:

parse structure or other general features exposed by the slot grammar (XSG) parser);

question classifications (number, date, etc.)

binary features representing topical areas (e.g., question talks about medical treatment, pharmaceuticals, etc.);

binary features representing the source from which the answer came; and,

additional features of the question and/or answers.

Using the identified features 412-414 of the question and answers, as well as known correct answers from labeled training set 401, machine learning component 415 trains authority model 405. In one embodiment, training set 401 is labeled with known correct answers for sources of correct answer and sources of incorrect answers. In one embodiment, machine learning component 415 considers two instances: a true instance and a false instance. For true relations, machine learning component 415 adds a binary 1 for each document source providing support for the correct answer. For false relations, machine learning component 415 adds a binary 0 for each document source that did not produce a correct answer.

Machine learning component 415 may keep track of the percentage of correct answers from each document source for each combination of features considered. Machine learning component 415 then trains authority model 405 based on the appropriate percentage of correct answers for each combination of features.

In an alternate embodiment, a subject matter expert provides authority score values for document sources for each combination of features either in labeled training set 401 or via user input 403. Machine learning component 415 then trains authority model 405 based on the known authority values for document sources and corresponding question topics.

Consider the following example:

Question: What country has the lowest per capita GDP among former Soviet Republics?

LAT: country

QClass: REGIONAL and ECONOMIC

Answer: Tajikistan

Sources:
1. RT (Russia Today): “The CIA World Factbook reports that of the former Soviet Republics, Tajikistan has the lowest per capita GDP.”
2. Embassy cable: “The uncertain outcome of the regional crisis may stem in part from the economic stability issues in Tajikistan whose per capita GDP is the lowest”
3. Pravda did not provide a correct answer.

The following are training instances for the Tajikistan answer:

QuestionID=0000001, QClass-DATE=0, QClass-NUMBER=0, QClass-REGIONAL=1, QClass-ECONOMIC=1, LATConfidence=0.95, Source-RT=1, Source-Embassy=1, Source-Pravda=0, correct=1; and

QuestionID=0000001, QClass-DATE=0, QClass-NUMBER=0, QClass-REGIONAL=, QClass-ECONOMIC=1, LATConfidence=0.95, Source-RT=Source-Embassy=0, Source-Pravda=1, correct=0.

For the above instances, machine learning component 415 would learn that the sources Russia Today and Embassy cable may be likely to provide a correct answer for questions in the question classification/topic of REGIONAL and/or ECONOMIC, while the source Pravda may not be likely to provide a correct answer for the same question classifications or topics. Given hundreds or thousands of training instances, machine learning component 415 then determines weights for computing an authority score. IN one embodiment, RA pipeline 411 determines the authority score using the following equation:

Score=X1*W1+X2*W2+X3*W3+X4*W4+X5*W5+C,

where X1, X2, X3, X4, and X5 are question and/or answer features, W1, W2, W3, W4, and W5 are weights (β values) determined by machine learning component 415, and C is a constant determined by machine learning component 415. In the above example, X1 is QClass-DATE, X2 is QClass-NUMBER, X3 is QClass-REGIONAL, X4 is QClass-ECONOMIC, and X5 is LATConfidence, although in an actual implementation, there would likely be many different question topics, perhaps hundreds. In other embodiments, RA pipeline 411 may use other question and/or answer features in determining an authority score for a source of an answer.

Machine learning component 415 stores the weights in authority model 405. For each labeled question/answer pair in training set 401, machine learning component 415 refines authority model 405. Training set 401 may be labeled with known answers and even known authority score values to help refine authority model 405. Alternatively, a subject matter expert may provide user input 403 to identify correct answers and to identify source documents that are known to provide correct answers.

FIG. 5 is a block diagram illustrating a question answering system for determining authority score values for source documents in a corpus in accordance with an illustrative embodiment. QA system 510 receives a question 501 and generates a set of candidate answers 504 based on corpus 502. Reasoning algorithm (RA) pipeline 511 generates question features 512 (e.g., T), answer features 513 (e.g., source(s) of supporting evidence for answer(s)), and question class/topic features 514 (e.g., QClass-DATE, QClass-NUMBER, QClass-ECONOMIC, QClass-REGION, etc.).

Authority score engine 515 uses authority model 503 to compute authority score(s) 505 for candidate answer(s) 504 based on question features 512, answer features 513, and class/topic features 514. More particularly, authority score engine 515 computes authority scores 505 for each document source by applying weights from authority model 503 to features 512-514. In one embodiment, authority engine 515 uses the set of LAT confidence, binary question classification features, and binary question topic features to calculate authority scores 505 using the equation shown above.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the forgoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

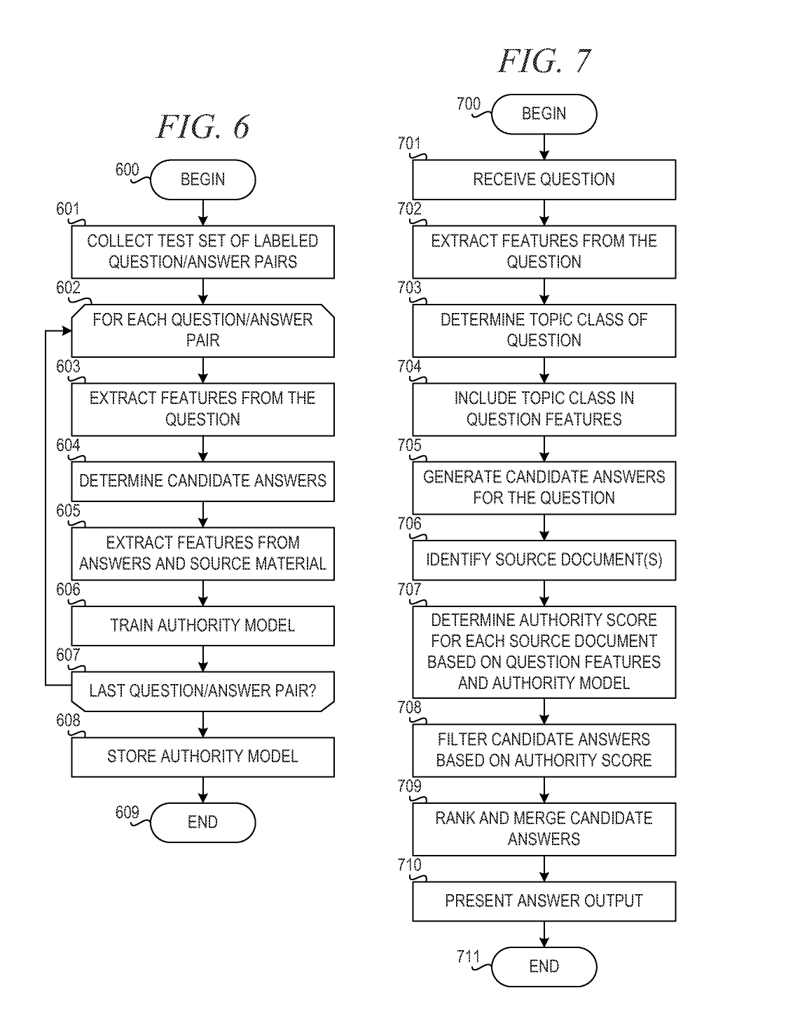

FIG. 6 is a flowchart illustrating operation of a mechanism for training a model for measuring authority of a document source for the answer to a question in accordance with an illustrative embodiment. Operation begins (block 600), and the mechanism collects a training set of labeled question/answer pairs (block 601). For each question/answer pair (block 602), the mechanism extracts features from the question (block 603). The question features may include LAT, question classifications, and question topics, for example. The mechanism then determines a set of one or more candidate answers (block 604). The mechanism then extracts features from answers and source material (block 605). The mechanism trains the authority model based for document sources for correct answers and incorrect answers based on question features, such as LAT, question classifications, and question topics (block 606).

The mechanism then determines whether the question/answer pair is the last question/answer pair in the training set (block 607). If the question/answer pair is not the last question/answer pair, operation returns to block 602 to consider the next question/answer pair. The mechanism then refines the authority model, which becomes more accurate as the number of question/answer pairs increases. If the question/answer pair is the last question/answer pair in block 607, then the mechanism stores the authority model (block 608). Thereafter, operation ends (block 609).

FIG. 7 is a flowchart illustrating operation of a mechanism for measuring authority of a document source of an answer to a question in accordance with an illustrative embodiment. Operation begins (block 700), and the mechanism receives an input question (block 701) and extracts features from the question (block 702). The mechanism determines a topic class of the question (block 703) and includes the topic class feature values in the question features (block 704).

The mechanism generates candidate answers for the question (block 705). The mechanism then identifies the source document(s) providing support for the candidate answers (block 706). The mechanism then determines an authority score for each document source based on the question features and the authority model (block 707). Then, the mechanism optionally filters the candidate answers based on the authority scores (block 708).

The mechanism ranks and merges the candidate answers (block 709). In the final merging and ranking, the mechanism may determine final answer confidence scores based on the authority scores of the supporting document sources. The mechanism presents answer output (block 710), and operation ends (block 711). In one embodiment, the mechanism may present the authority scores with the candidate answers.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide a mechanism for measuring authority of a source of documents in a corpus providing support for answers of questions in a question answering system. The mechanism may be integrated into the question answering system as a filtering mechanism such that candidate answers supported by document sources with authority values that are less than a predetermined threshold are eliminated prior to running resource intensive deep scorers. Alternatively, the mechanism may be integrated as an additional feature within the final merger machine learning model. The mechanism would be used to propagate authority information into the normal full phase machine learning models and allow the logistic regression model to determine its usefulness in question answering.

As noted above, it should be appreciated that the illustrative embodiments may take the form of an entirety hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for determining source authority for an answer to a question, the method comprising:
receiving an input question from a user interface;
determining a set of answers to the input question from a corpus of information, wherein the corpus of information comprises a plurality of sources of information;
for a given answer in the set of answers, identifying a given source of a supporting passage;
determining an authority score of the given source for the input question; and
presenting the set of answers to the user interface based on the authority score for the given source.

2. The method of claim 1, wherein determining the authority score comprises:
identifying a plurality of feature values of the input question; and
determining the authority score based on the plurality of feature values of the input question using a machine learning model.

3. The method of claim 2, wherein identifying the plurality of feature values of the input question comprises determining a question class binary value for each of a plurality of predetermined question classes, wherein each question class binary value indicates presence or non-presence of the input question in a corresponding question class.

4. The method of claim 2, wherein identifying the plurality of feature values of the input question comprises determining a topical class binary value for each of a plurality of predetermined topical classes, wherein each topical class binary value indicates presence or non-presence of the input question in a corresponding topical class.

5. The method of claim 2, wherein the plurality of feature values comprise one or more features determined from the input question.

6. The method of claim 1, wherein identifying the given source of the supporting passage comprises determining a source binary value for each of the plurality of sources of information, wherein each source binary value indicates presence or non presence of a supporting passage from the source of information in a given answer.

7. The method of claim 1, further comprising removing the given answer from the set of answers responsive to determining the authority score is less than a predetermined threshold.

8. The method of claim 7, wherein the given answer is removed from the set of answers prior to running resource-intensive deep scorers.

9. The method of claim 1, further comprising determining a confidence score for the given answer based on the authority score.

10. The method of claim 1, further comprising ranking the set of answers based on authority score.

11. A computer program product comprising a computer readable storage medium having a computer readable program stored therein, wherein the computer readable program, when executed on a computing device, causes the computing device to:
receive an input question from a user interface;
determine a set of answers to the input question from a corpus of information, wherein the corpus of information comprises a plurality of sources of information;
for a given answer in the set of answers, identify a given source of a supporting passage;
determine an authority score of the given source for the input question; and
present the set of answers to the user interface based on the authority score for the given source.

12. The computer program product of claim 11, wherein determining the authority score comprises:
identifying a plurality of feature values of the input question; and
determining the authority score based on the plurality of feature values of the input question using a machine learning model.

13. The computer program product of claim 12, wherein identifying the plurality of feature values of the input question comprises determining a question class binary value for each of a plurality of predetermined question classes, wherein each question class binary value indicates presence or non-presence of the input question in a corresponding question class.

14. The computer program product of claim 12, wherein identifying the plurality of feature values of the input question comprises determining a topical class binary value for each of a plurality of predetermined topical classes, wherein each topical class binary value indicates presence or non-presence of the input question in a corresponding topical class.

15. The computer program product of claim 11, wherein identifying the given source of the supporting passage comprises determining a source binary value for each of the plurality of sources of information, wherein each source binary value indicates presence or non-presence of a supporting passage from the source of information in a given answer.

16. The computer program product of claim 11, wherein the computer readable program further causes the computing device to removing the given answer from the set of answers responsive to determining the authority score is less than a predetermined threshold.

17. The computer program product of claim 11, wherein the computer readable program further causes the computing device to determining a confidence score for the given answer based on the authority score.

18. An apparatus comprising:
a processor; and
a memory coupled to the processor, wherein the memory comprises instructions which, when executed by the processor, cause the processor to:
receive an input question from a user interface;
determine a set of answers to the input question from a corpus of information, wherein the corpus of information comprises a plurality of sources of information;
for a given answer in the set of answers, identify a given source of a supporting passage;
determine an authority score of the given source for the input question; and
present the set of answers to the user interface based on the authority score for the given source.

19. The apparatus of claim 18, wherein determining the authority score comprises:
identifying a plurality of feature values of the input question; and
determining the authority score based on the plurality of feature values of the input question using a machine learning model.

20. The apparatus of claim 19, wherein identifying the plurality of feature values of the input question comprises determining a topical class binary value for each of a plurality of predetermined topical classes, wherein each topical class binary value indicates presence or non-presence of the input question in a corresponding topical class.
